(19) United States
(12) Patent Application Publication
(10) Pub. No.: US 2025/0330799 A1
(43) Pub. Date: Oct. 23, 2025

(54) SYSTEMS AND METHODS FOR ENABLING SLICE SUBSCRIPTION CHANGES

(71) Applicant: Verizon Patent and Licensing LLC, Basking Ridge, NJ (US)

(72) Inventors: Andrew E. YOUTZ, Princeton, NJ (US); Samirkumar PATEL, Middlesex, NJ (US); Chintankumar PATEL, Edison, NJ (US)

(73) Assignee: Verizon Patent and Licensing LLC, Basking Ridge, NJ (US)

(21) Appl. No.: 18/643,705

(22) Filed: Apr. 23, 2024

(51) Int. Cl. H04W 8/20; H04W 40/22; H04W 48/02; H04W 48/18

(52) U.S. Cl. CPC H04W 8/20; H04W 40/22; H04W 48/02; H04W 48/18

(57) ABSTRACT

In some implementations, a network-connected device may receive, from a network entity, a network subscription status update that indicates that the network-connected device is permitted to access a network slice for which the network-connected device has an associated back off timer running. The network-connected device may clear the back off timer based on receiving the network subscription status update. The network-connected device may transmit, to the network entity, a packet data unit session request associated with the network slice based on clearing the back off timer.

### BACKGROUND

The field of telecommunications encompasses the orchestration of network capabilities and the administration of user access to facilitate a range of services. Network slicing represents a method for establishing distinct virtual networks atop a shared physical framework. In some cases, network slicing may be associated with the selection and/or allocation of network resources into various network slices to suit the requirements of a specific service. For example, a network slice associated with an enhanced mobile broadband (eMBB) service may support high throughputs and/or a network slice associated with an ultra-reliable low latency communications (URLLC) service may support low latency, among other examples.

### BRIEF DESCRIPTION OF THE DRAWINGS

FIGS. 1A-1G are diagrams of an example associated with enabling slice subscription changes.

FIGS. 2A-2B are diagrams of an example flow diagram associated with enabling slice subscription changes.

FIG. 3 is a diagram of an example environment in which systems and/or methods described herein may be implemented.

FIG. 4 is a diagram of example components of a device associated with enabling slice subscription changes.

FIG. 5 is a flowchart of an example process associated with enabling slice subscription changes.

### DETAILED DESCRIPTION OF EXAMPLE EMBODIMENTS

The following detailed description of example implementations refers to the accompanying drawings. The same reference numbers in different drawings may identify the same or similar elements.

In the realm of telecommunications, such as within the context of Fifth Generation (5G) wireless networks, network slicing may be employed to support diverse service requirements. Network slicing allows the creation of multiple virtual networks on a common physical infrastructure, each tailored to serve a specific application or service, such as gaming or low latency applications, among other examples. These network slices are identified by unique identifiers, known as single network slice selection assistance information (S-NSSAI), and may be associated with one or more data network names (DNNs) to provide the necessary connectivity to users for specific services.

In some examples, a user device (e.g., a user equipment (UE)) that is not subscribed to a specific network slice may attempt to access the network slice, such as by initiating a packet data unit (PDU) session with an un-subscribed slice (e.g., such as by initiating a PDU session associated with an S-NSSAI and DNN combination for which the UE is not subscribed). In such cases, the network may reject the PDU session request and/or may issue a permanent failure error code to the user device to prevent future unwanted retries from the device. For example, the permanent failure error code may trigger a back off timer at the user device (sometimes referred to as a permanent back off timer, which may be a network-imposed back off timer signaled to the user device by the network (e.g., a network-provided value), a back off timer hard-coded at the user device (e.g., a pre-configured value), or a similar back off timer). The back off timer may prevent the user device from attempting to access the network slice (e.g., may prevent the user device from transmitting a PDU session request with an S-NSSAI and DNN combination for which the UE is not subscribed) for a certain period of time (e.g., 24 hours) and/or until the device is power-cycled, among other examples.

In some examples, a user may be able to dynamically change a subscription, such as by temporarily subscribing to a service via a temporary pass (e.g., a gaming day pass or a similar day pass), which may allow the user to access the previously un-subscribed network slice. However, due to the running back off timer at the user device, the user may nonetheless be unable to connect to the network slice. As a result, users who have updated their subscription to access a previously un-subscribed network slice may be hindered by the back off timer and/or may be unable to utilize the new services without taking some additional action, such as performing a power cycle of the user device. This may result in high latency, high power consumption, and otherwise inefficient network operations, particularly in scenarios where network slicing subscriptions are permitted to be changed frequently and/or dynamically.

Some implementations described herein enable improved telecommunications network operations, such as improved telecommunications network operations in connection with dynamic network slicing subscription changes. Some implementations include receiving, by a network-connected device from a network entity, a network subscription status update that allows access to a network slice for which there is an active back off timer running on the device (e.g., due to a previously rejected PDU session request, among other examples). The network-connected device may be configured to clear the back off timer in response to receiving the update, thereby permitting subsequent attempts to access the previously un-subscribed network slice. For example, in response to clearing the back off timer, the network-connected device may transmit a PDU session request associated with the network slice (e.g., a PDU session request indicating the S-NSSAI and DNN combination for which the back off timer was running) and/or may establish a PDU session with the network that uses the network slice.

In this way, the method improves network resource allocation and reduces unnecessary signaling traffic. By clearing the back off timer in response to a subscription update, the device may immediately attempt to establish a PDU session with the newly subscribed network slice, thereby conserving processing resources, memory resources, network resources, and/or the like. As a result, some implementations describe herein enable more efficient use of network resources by minimizing the time and processing power wasted on waiting for back off timers to expire and/or used to clear back off timers by power cycling a device, among other examples.

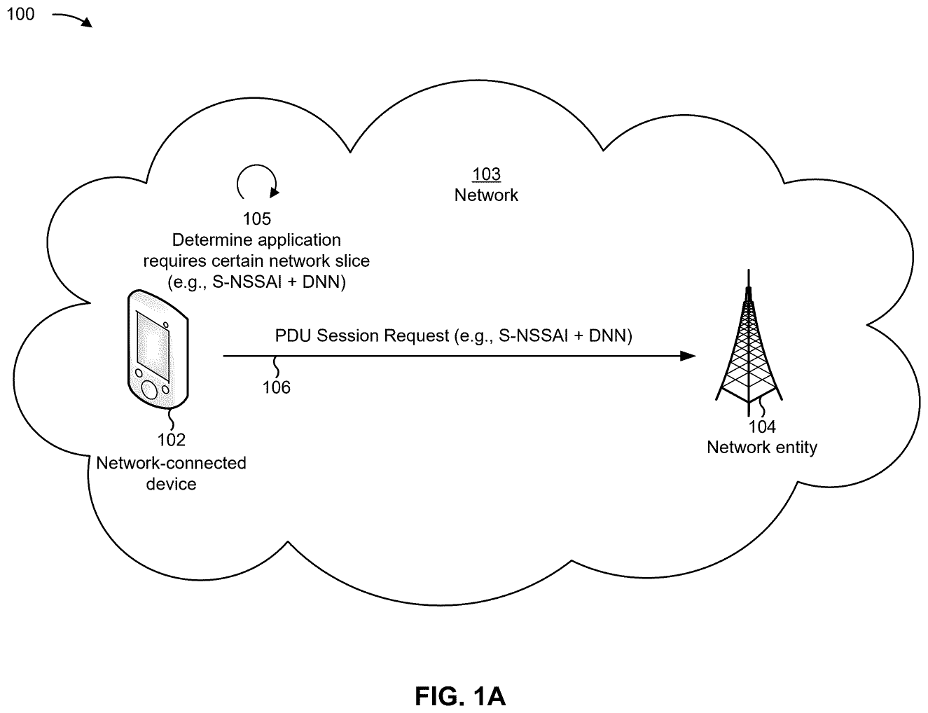

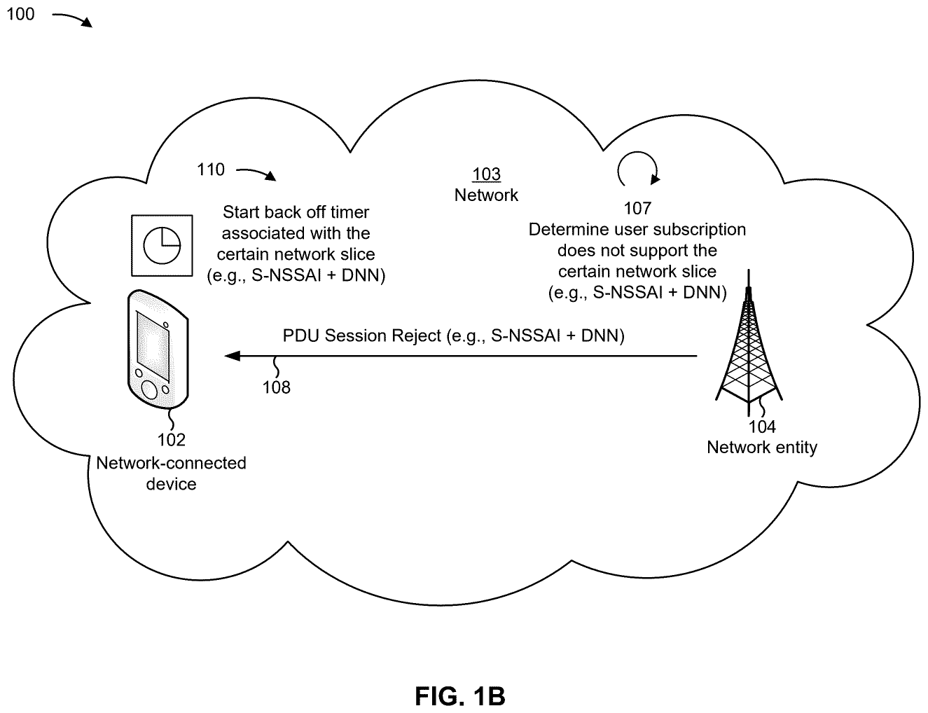

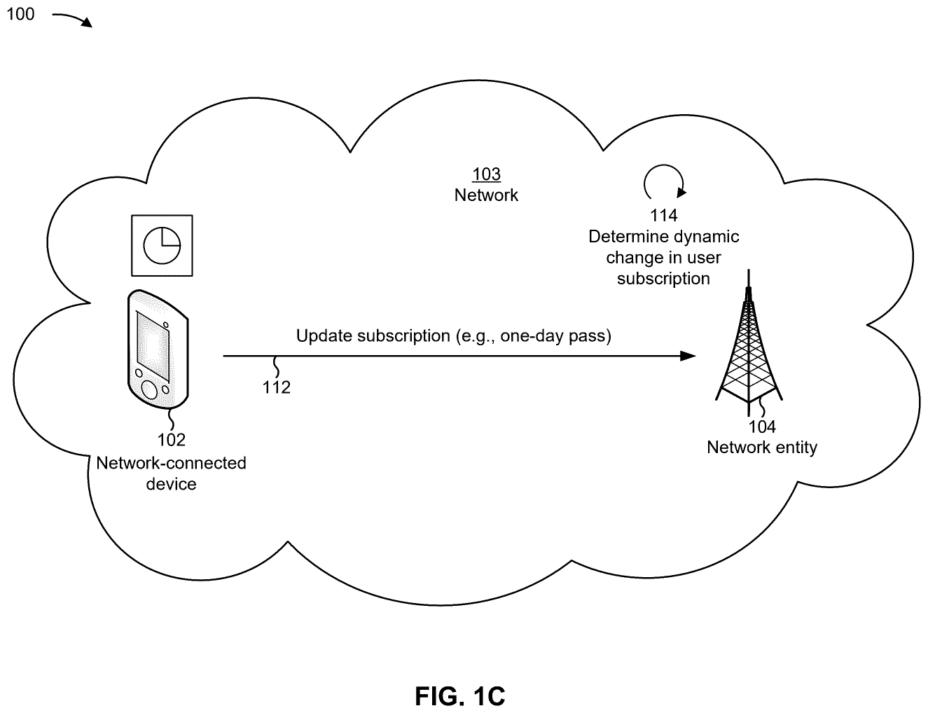

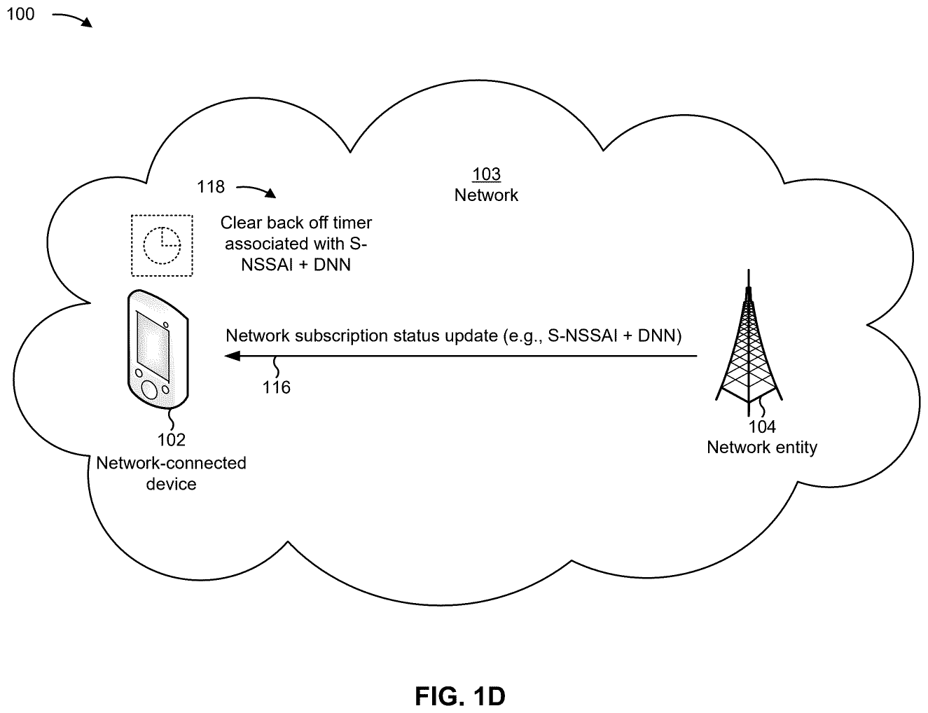

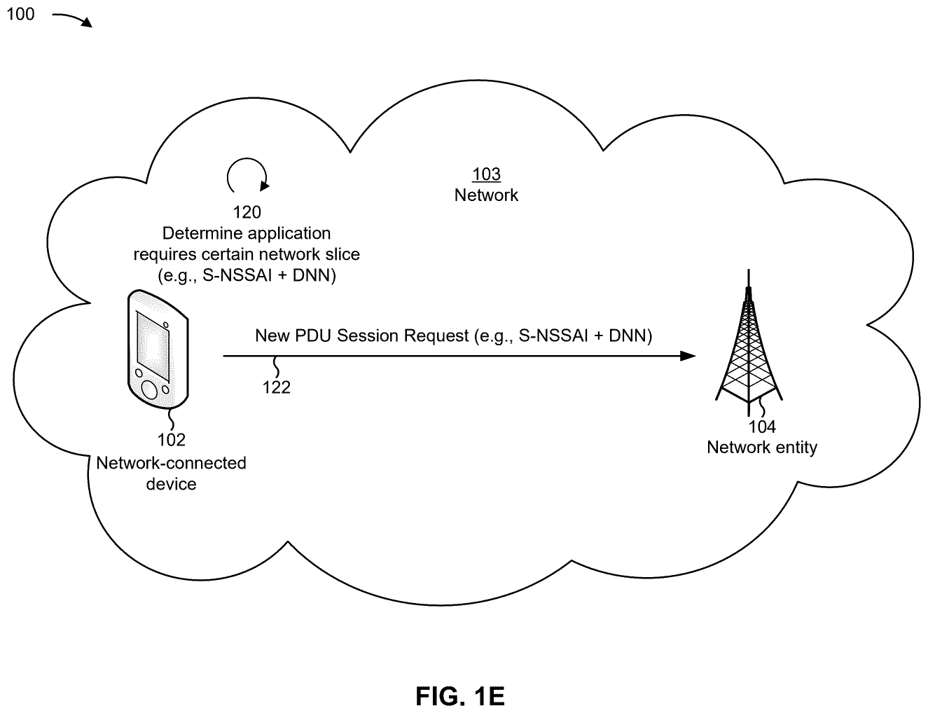

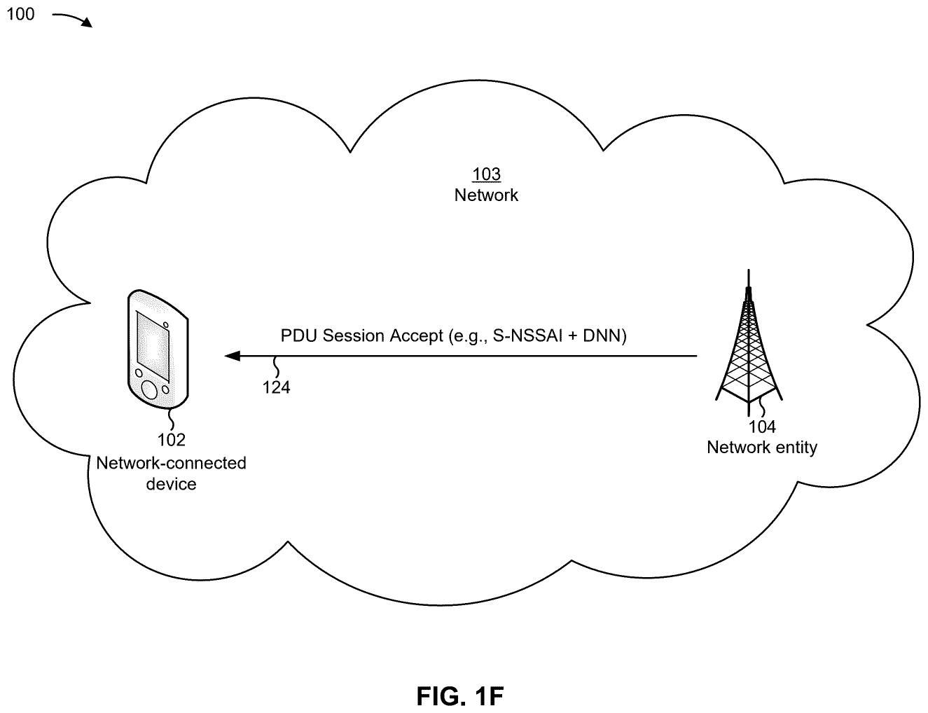

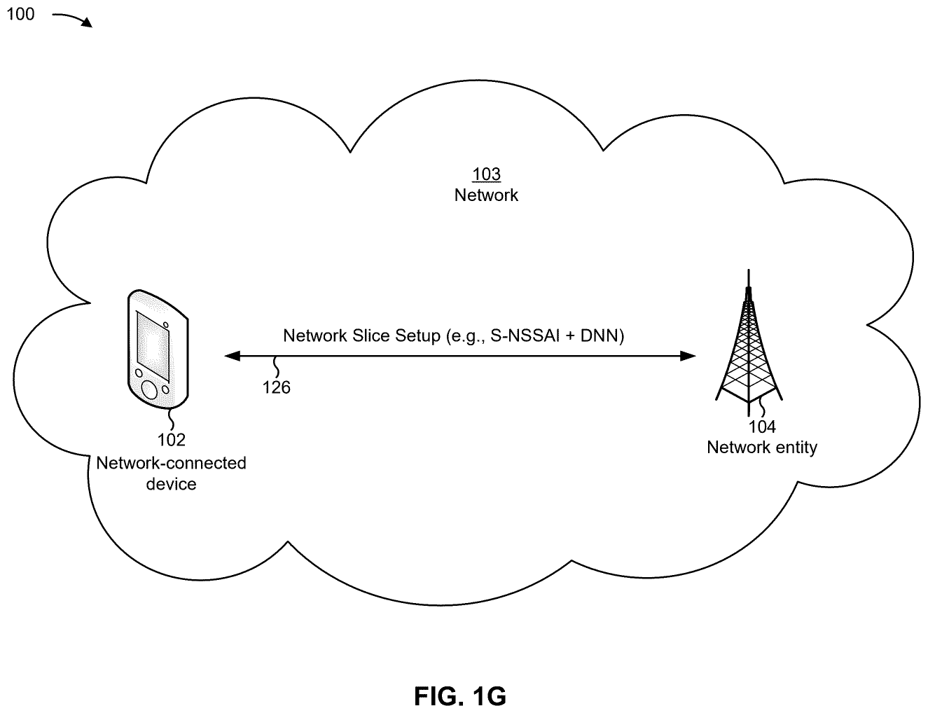

FIGS. 1A-1G are diagrams of an example 100 associated with enabling slice subscription changes. As shown in FIGS. 1A-1G, example 100 includes a network-connected device 102 (e.g., a UE) and a network entity 104 (e.g., a base station or similar radio access network (RAN) entity) in communication with each other via a network 103 (e.g., a wireless communication network, such as a 5G wireless network, among other examples).

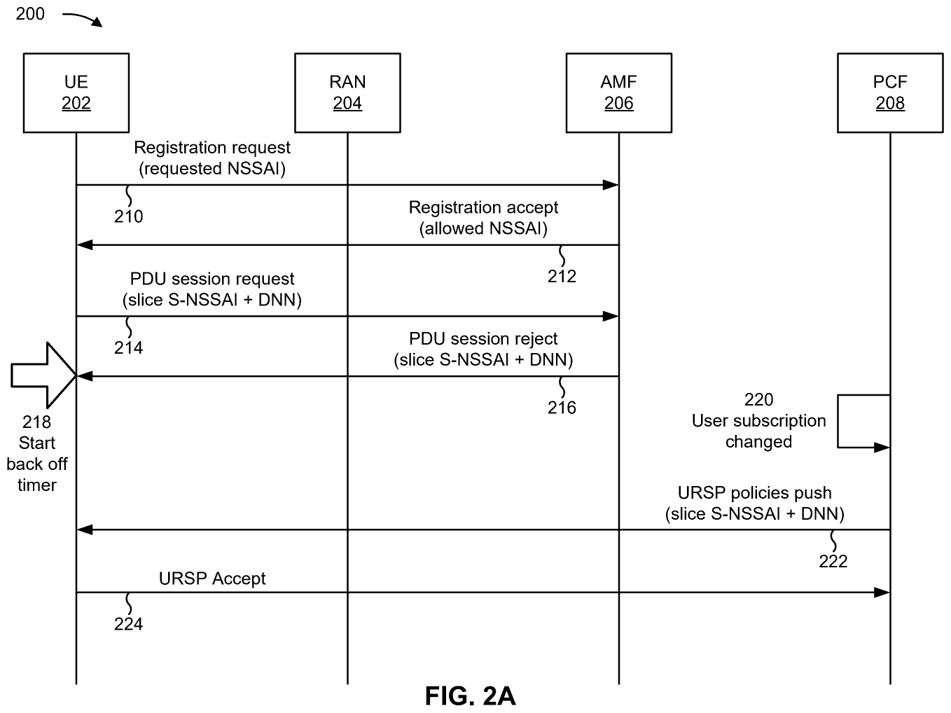

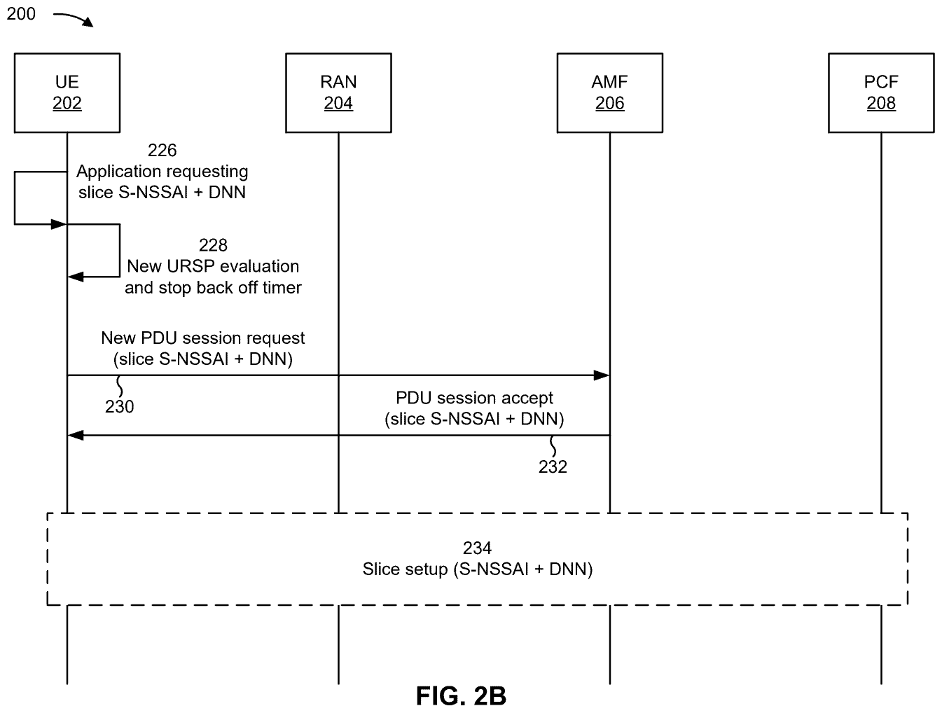

As shown by FIG. 1A, and as indicated by reference number 105, the network-connected device 102 may determine a network slice that is to be requested by the network-connected device 102. For example, an application running at the network-connected device 102 may require access to a certain network slice, such as a gaming slice, a low latency slice, a high throughput slice, or a similar type of network slice. In some implementations, the network-connected device 102 may determine one or more identifiers associated with the network slice. For example, the network-connected device 102 may determine a slice identifier (e.g., an S-NSSAI, which may uniquely identify the network slice to be accessed and/or which may be a concatenation of a slice/service type (SST) and a slice differentiator (SD), which is described in more detail below in connection with FIGS. 2A and 2B) and/or a data network identifier (e.g., a DNN, which may uniquely identify the data network to be accessed) that is to be accessed using the network slice.

As indicated by reference number 106, the network-connected device 102 may transmit, and the network entity 104 may receive, a request to access the network slice. For example, the network-connected device 102 may transmit a PDU session request associated with the network slice (e.g., a request to establish a PDU session using the network slice), such as a PDU session request that requests access to a gaming slice, a low latency slice, a high throughput slice, and/or a similar type of slice, even if the user is not currently subscribed to that particular slice. In some implementations, the PDU session request may identify the network slice using one or more identifiers. For example, in implementations in which the network slice is associated with an S-NSSAI and DNN combination, the PDU session request may include an indication of the S-NSSAI and DNN combination.

As shown by FIG. 1B, and as indicated by reference number 107, the network entity 104 (e.g., a policy control function (PCF) associated with the network entity 104) may determine that a user subscription (e.g., a subscription associated with a user of the network-connected device 102) does not support the network slice. Put another way, in response to receiving the PDU session request, the network entity 104 may check a subscription associated with the network-connected device 102 (e.g., a subscription of a user of the network-connected device 102) and may determine that the subscription does not include access to the network slice requested by the PDU session request described above in connection with reference number 106 (e.g., the network slice identified by the S-NSSAI and DNN combination included in the PDU session request). Accordingly, as indicated by reference number 108, the network entity 104 may transmit, and the network-connected device 102 may receive, a PDU session reject communication indicating that the network-connected device 102 is not permitted to access the requested network slice. For example, the PDU session reject communication may reject the PDU session request by using a permanent failure error code or a similar code based on determining that that the user's subscription does not support the requested network slice.

In some implementations, the permanent failure error code may be a code used by the network entity 104 to indicate to the network-connected device 102 that a back off timer is to be started at the network-connected device 102. In some implementations, a back off timer may be associated with a period of time during which the network-connected device 102 is not permitted to request access to the network slice for which the PDU session request was previously rejected. In some implementations, a duration of the back off timer and/or other configuration information associated with the back off timer may be signaled to the network-connected device 102 by the network entity 104, such as via the PDU session reject communication described above in connection with reference number 108 and/or another communication (e.g., a radio resource control (RRC) communication, a medium access control (MAC) control element (MAC-CE) communication, a downlink control information (DCI) communication, and/or a similar communication). In some other implementations, the duration of the back off timer and/or other configuration information associated with the back off timer may be per-configured (e.g., hard-coded) at the network-connected device 102.

Accordingly, as indicated reference number 110, the network-connected device 102 may start the back off timer (depicted using a timer icon proximate to the network-connected device 102 in FIG. 1B) based on receiving the PDU session reject communication. For example, the network-connected device 102 may initiate a back off timer associated with a duration and/or one or more configuration parameters signaled to the network-connected device 102 by the network entity 104 and/or hard-coded at the network-connected device 102. In some implementations, as long as the back off timer is running, the network-connected device 102 may not transmit requests (e.g., PDU session requests) to access the network slice associated with the back off timer (e.g., the network-connected device 102 may not attempt to access a network slice for which the network-connected device 102 previously received a permanent failure error code while an associated back off timer is running). In that regard, if an application running at the network-connected device 102 requests access to the network slice (e.g., the network slice associated with the S-NSSAI and DNN combination for which the network-connected device 102 received a PDU session reject communication) during the pendency of the corresponding back off timer, the network-connected device 102 will not transmit a request to access the network slice. In some implementations, a back off timer may run at the network-connected device 102 until a period of time (e.g., 24 hours) has elapsed or else until the network-connected device 102 is power cycled (e.g., until the network-connected device 102 is turned off completely and turned back on again to clear the device's random access memory (RAM) and/or reset the device's operating system (OS), resulting in a reset of the network-connected device 102's hardware and/or software components), among other examples, in order to prevent immediate retries of the PDU session request for the un-subscribed slice.

As shown by FIG. 1C, a user may be permitted to dynamically update a subscription, such as for a purpose of gaining access to one or more previously un-subscribed network slices. For example, a user may be permitted to purchase a temporary pass (e.g., a one-day gaming pass) and/or may be permitted to otherwise dynamically access a previously un-subscribed network slice. Accordingly, in some implementations, as indicated by reference number 112, the network-connected device 102 may transmit, and the network entity 104 may receive, a communication associated with updating a subscription of a user associated with the network-connected device 102 (e.g., to purchase a one-day pass to the network slice, among other examples). Moreover, as indicated by reference number 114, the network entity 104 (e.g., a PCF associated with the network entity 104) may determine that there has been a change in the user's subscription. For example, the network entity 104 may identify that the user has dynamically subscribed to a temporary pass and/or has otherwise subscribed to one or more previously un-subscribed network slices.

As shown in FIG. 1D, and as indicated by reference number 116, based on detecting a change in the user's subscription, the network entity 104 may transmit, and the network-connected device 102 may receive, a network subscription status update indicating that the user is now subscribed to a previously unsubscribed network slice. In some implementations, the network subscription status update may indicate one or more S-NSSAI and DNN combinations for which the user was previously un-subscribed but for which the user is now subscribed. Put another way, the network-connected device 102 may receive, from the network entity 104, a network subscription status update that indicates that the network-connected device 102 is permitted to access a network slice for which the network-connected device 102 has an associated back off timer running. In some implementations, the network subscription status update may be transmitted by the network entity 104 using a UE route selection (URSP) rules update (sometimes referred to as a URSP policies push). For example, in response to identifying a change in the user's subscription, the network entity 104 (e.g., a PCF associated with the network entity 104) may transmit a URSP rules update communication indicating one or more S-NSSAI and DNN combinations for which the user is newly subscribed.

In some implementations, the network-connected device 102 may have a back off timer running for one or more network slices (e.g., S-NSSAI and DNN combinations) indicated by the network subscription status update (e.g., the URSP rules update communication). For example, as described above in connection with reference number 110, the network-connected device 102 may have started a back off timer for the particular S-NSSAI and DNN combination included in the PDU session request for which a permanent failure error code or similar communication from the network entity 104 was received. In some implementations, based on receiving the network subscription status update, the network-connected device 102 may be capable of clearing (e.g., stopping) these back off timers without waiting for an associated time period (e.g., 24 hours) to elapse and/or without requiring power cycling of the network-connected device 102, thereby reducing latency associated with network communications and/or conserving power, computing, and network resources associated with a shutdown and restart procedure of the network-connected device 102. More particularly, as indicated by reference number 118, the network-connected device 102 may clear the back off timer (depicted using broken lines in connection with the timer icon proximate to the network-connected device 102 in FIG. 1D) in response to receiving the network subscription status update. For example, upon receipt and evaluation of the updated URSP rules and/or upon evaluation of the subscribed and/or configured one or more S-NSSAIs indicated by the updated URSP rules, the network-connected device 102 may stop or clear any back off timers for PDU sessions associated with a network slice (e.g., an S-NSSAI and DNN combination) for which the user is now subscribed.

As shown by FIG. 1E, and as indicated by reference number 120, the network-connected device 102 may determine a network slice that is be accessed by the network-connected device 102, which may be substantially similar to the operations described above in connection with reference number 105. More particularly, the network-connected device 102 may determine one or more identifiers (e.g., an S-NSSAI and DNN combination) associated with a network slice (e.g., a gaming slice, a low latency slice, a high throughput slice, or a similar type of network slice) that an application running at the network-connected device 102 requests access to. In some implementations, the network slice (e.g., the S-NSSAI and DNN combination) may correspond to a network slice for which the network-connected device 102 previously received a permanent failure code or similar communication, such as via the signaling described above in connection with reference number 108. Nonetheless, because the network-connected device 102 may have cleared an associated back off timer in response to receiving the network subscription status update described above in connection with reference number 116 (e.g., the URSP policies push), the network-connected device 102 may now transmit a new PDU session request or similar communication requesting access to the previously un-subscribed network slice. More particularly, as indicated by reference number 122, the network-connected device 102 may transmit, and the network entity 104 may receive, a new PDU session request associated with the network slice (e.g., a PDU session request that indicates the S-NSSAI and DNN combination). Put another way, the network-connected device 102 may attempt to establish a PDU session with the newly subscribed network slice without the need to power-cycle the network-connected device 102 and/or without waiting for a time period associated with the back off timer (e.g., 24 hours) to elapse.

As shown by FIG. 1F, and as indicated by reference number 124, the network entity 104 may transmit, and the network-connected device 102 may receive, a PDU session accept communication based on transmitting the PDU session request indicating the request to access the previously un-subscribed network slice. Put another way, the network entity 104 may accept the PDU session request for the network slice (e.g., the S-NSSAI and DNN combination) that the user is now subscribed to, allowing the user to use applications associated with the newly subscribed network slice without requiring resource consumption and/or delay associated with power cycling the network-connected device 102. Accordingly, as shown by FIG. 1G, and as indicated by reference number 126, the network-connected device 102 and/or the network entity 104 may perform a network slice setup procedure, such as by establishing a PDU session associated with specific S-NSSAI and DNN combination.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

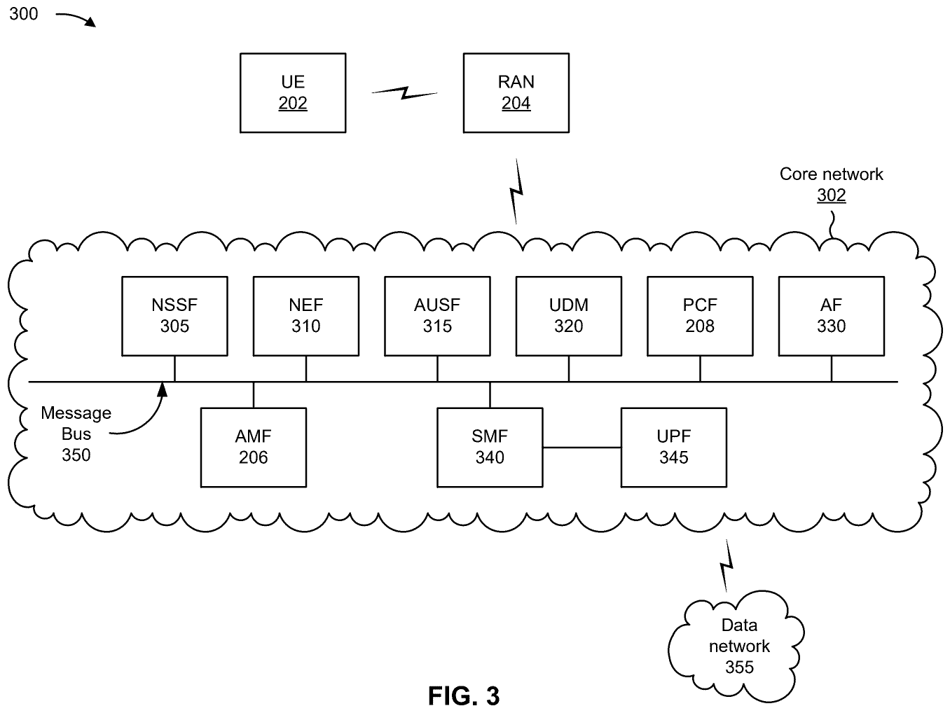

FIGS. 2A-2B are diagrams of an example flow diagram 200 associated with enabling slice subscription changes. As shown in FIGS. 2A-2B, the example flow diagram 200 includes a UE 202, a RAN 204, an access and mobility management function (AMF) 206, and a PCF 208. In some implementations, the UE 202 may correspond to the network-connected device 102 described above in connection with FIGS. 1A-1G. Additionally, or alternatively, one or more of the RAN 204, the AMF 206, and/or the PCF 208 may correspond to the network entity 104 described above in connection with FIGS. 1A-1G. For example, the UE 202 may be configured to communicate with the RAN 204 over an access network (e.g., using a Uu interface), the RAN 204 may be configured to communicate with the AMF 206 via a wired or wireless backhaul (e.g., via non-access stratum (NAS) signaling and/or via an N2 interface), and/or the AMF 206 may be configured to communication with the PCF 208 (e.g., via an N15 interface). Accordingly, the UE 202 may be capable of communicating with the RAN 204 directly (e.g., over an access network), with the AMF 206 indirectly via the RAN 204, and/or with the PCF 208 indirectly via the RAN 204 and the PCF 208. In such examples, the network entity 104 described above in connection with FIGS. 1A-1G may correspond to the RAN 204 and/or the one or more communications exchanged between the network-connected device 102 and the network entity 104 may correspond to communications ultimately exchanged between the UE 202 and the RAN 204, the UE 202 and the AMF 206 (e.g., indirectly via the RAN 204), and/or the UE 202 and the PCF 208 (e.g., indirectly via the RAN 204 and the AMF 206). In some implementations, one or more the devices shown in FIGS. 2A and 2B may be in communication via a wireless network, such as the 5G wireless network described in more detail below in connection with FIG. 3.

As shown by reference number 210, the UE 202 may transmit, and the AMF 206 may receive, a registration request. In some implementations, the registration request may include a set of requested S-NSSAIs, collectively referred to herein as NSSAI (e.g., NSSAI may refer to a set of one or more S-NSSAIs). In some implementations, the UE 202 may provide the requested NSSAI to the RAN 204 using an RRC setup complete message, and/or the RAN 204 may forward the requested NSSAI to the AMF 206 via the registration request message. Additionally, or alternatively, in some implementations, the requested NSSAI may include up to eight S-NSSAIs that the UE 202 would like to access. In some implementations, each S-NSSAI may include a concatenation of an SST and an SD. The SST may be 8 bits and/or may be used to indicate the expected network slice behavior in terms of features and/or services the slice supports (e.g., whether the network slice supports eMBB services, URLLC services, massive machine type communications (mMTC) services, gaming services, and/or similar services). The SD may be 16 bits and/or may be used to differentiate between network slices having the same SST value, such as in implementations in which a network offers a same service type to multiple subscriber groups (e.g., a first subscriber group may be associated with a network slice having an SST value of 1 and an SD value of 1, a second subscriber group may be associated with a network slice having an SST value of 1 and an SD value of 2, and so forth).

As shown by reference number 212, the AMF 206 may transmit, and the UE 202 may receive, a registration accept communication. In some implementations, the registration accept communication may indicate an allowed NSSAI (e.g., a set of one or more allowed S-NSSAIs) and/or a configured NSSAI (e.g., a set of one or more configured S-NSSAIs). The allowed NSSAI may include the set of S-NSSAIs that a core network (e.g., a 5G core network) has authorized for the UE 202. In some implementations, the allowed NSSAI may include up to eight S-NSSAIs authorized for the UE 202 (e.g., the UE 202 may be served by up to eight network slices, such as by establishing up to eight PDU sessions). The configured NSSAI may include a general set of S-NSSAIs that are available within a specific public land mobile network (PLMN). In some implementations, the configured NSSAI may include up to sixteen S-NSSAIs available for the PLMN.

As indicated by reference number 214, the UE 202 may transmit, and the AMF 206 may receive, a PDU session request (sometimes referred to as a PDU session establishment request message). The PDU session request may request that a PDU session be established between the UE 202 and a DNN (which may be associated with an external data network (e.g., data network 355 described below in connection with FIG. 3) and/or which may define an interface between the core network and an external data network). In that regard, the PDU session request may indicate a requested network slice to be used by the UE 202 and/or a specific DNN to be accessed by the UE 202. For example, the PDU session request may indicate an S-NSSAI and DNN combination associated with a network slice requested by the UE 202.

As indicated by reference number 216, the AMF 206 may transmit, and the UE 202 may receive, a PDU session reject communication (sometimes referred to as a PDU session establishment request message). The PDU session reject communication may indicate that a specific network slice requested by the UE 202 (e.g., a specific requested S-NSSAI and DNN combination) is not allowed and/or is not supported by a user subscription. For example, the AMF 206 may transmit the PDU session reject communication in response to determining that a network slice requested by the UE 202 is not covered by a subscription of a user associated with the UE 202. In some implementations, the PDU session reject communication may indicate a permanent failure code. The permanent failure code may be used by the network to indicate to the UE 202 that the UE 202 is not to attempt to access the corresponding network slice (e.g., that the UE 202 is not to attempt to establish a PDU session for the corresponding S-NSSAI and DNN combination) for a certain period of time, such as a period of time associated with a back off timer (e.g., 24 hours) or until the UE 202 is power-cycled, whichever occurs first.

As indicated by reference number 218, in response to receiving the PDU session reject communication, the UE 202 may start a back off timer at the UE 202, which may prevent the UE 202 from attempting to establish another PDU session associated with the specific network slice (e.g., the specific S-NSSAI and DNN combination) until a period of time has elapsed (e.g., 24 hours) or until the UE 202 is power-cycled, among other examples. As described above in connection with FIGS. 1A-1G, in some implementations the period of time associated with the back off timer may be network signaled (e.g., indicated by a network entity to the UE 202, such as via RRC signaling, one or more MAC-CEs, and/or DCI), and/or may be pre-configured (e.g., hard-coded) at the UE 202.

As indicated by reference number 220, the PCF 208 may determine that a user subscription has changed. For example, a user associated with the UE 202 may dynamically update their subscription, such as by signing up for a temporary pass (e.g., a one-day gaming pass, among other examples). In response, the PCF 208 may transmit, and the UE 202 may receive, a network subscription status update to the UE 202, such as by transmitting a URSP policies push, as indicated by reference number 222. The URSP policies push may indicate that a network slice for which a PDU session reject communication (e.g., the communication described above in connection with reference number 216) was previously sent is now subscribed to by the user. For example, the URSP policies push may indicate the now-subscribed network slice by including an S-NSSAI and DNN combination for which a back off timer (e.g., the back off timer described above in connection with reference number 218) is running. In some implementations, the UE 202 may transmit, and the PCF 208 may receive, an acknowledgement message, such as a URSP accept message, as shown in connection with reference number 224.

As shown in FIG. 2B, based on the new subscription information indicated by the URSP policies push message, the UE 202 may clear the back off timer associated with the corresponding network slice and/or may establish a PDU session associated with the network slice. More particularly, as indicated by reference number 226, an application running at the UE 202 may request access to the network slice (e.g., may request access to the S-NSSAI and DNN combination that was previously rejected by the network). Accordingly, as indicated by reference number 228, the UE 202 may perform a new URSP evaluation, such as by determining that the user is now subscribed to the network slice as indicated by the URSP rules received via the URSP policies push message described above in connection with reference number 222. Accordingly, notwithstanding that the period of time associated with the back off timer (e.g., 24 hours) has not elapsed and/or that the UE 202 has not been power-cycled, the UE 202 may attempt to establish a PDU session associated with the network slice.

More particularly, as indicated by reference number 230, the UE 202 may transmit, and the AMF 206 may receive, a new PDU session request, which may indicate the network slice (e.g., via a S-NSSAI and DNN combination) that was previously rejected by the network. Based on the user's change in subscription, the AMF 206 may accept the PDU session request and/or may transmit a PDU session accept communication (sometimes referred to as a PDU session establishment accept communication), as indicated by reference number 232. The PDU session accept communication may specify a network slice to be used for the PDU session, such as by indicating the network slice using the S-NSSAI and DNN combination. In some implementations, and as indicated by reference number 234, the various entities may then perform a network slice setup procedure, such as by establishing a PDU session associated with the slice indicated by the specific S-NSSAI and DNN combination. In this way, the various entities may establish a PDU session without waiting for a back off timer to expire and/or without power-cycling the UE 202, thereby reducing latency and resource consumption associated with network slicing operations and otherwise resulting in more efficient network device operations.

As indicated above, FIGS. 2A-2B are provided as an example. Other examples may differ from what is described with regard to FIGS. 2A-2B. The number and arrangement of devices shown in FIGS. 2A-2B are provided as an example. In practice, there may be additional devices, fewer devices, different devices, or differently arranged devices than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, or alternatively, a set of devices (e.g., one or more devices) shown in FIGS. 2A-2B may perform one or more functions described as being performed by another set of devices shown in FIGS. 2A-2B.

FIG. 3 is a diagram of an example environment 300 in which systems and/or methods described herein may be implemented. As shown in FIG. 3, example environment 300 may include the UE 202, the RAN 204, a core network 302, and the data network 355. Devices and/or networks of example environment 300 may interconnect via wired connections, wireless connections, or a combination of wired and wireless connections.

The UE 202 includes one or more devices capable of receiving, generating, storing, processing, and/or providing information, such as information described herein. For example, the UE 202 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 204 may support, for example, a cellular radio access technology (RAT). The RAN 204 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 202. The RAN 204 may transfer traffic between the UE 202 (e.g., using a cellular RAT), one or more base stations (e.g., using a wireless interface or a backhaul interface, such as a wired backhaul interface), and/or the core network 302. The RAN 204 may provide one or more cells that cover geographic areas.

In some implementations, the RAN 204 may perform scheduling and/or resource management for the UE 202 covered by the RAN 204 (e.g., the UE 202 may be covered by a cell provided by the RAN 204). In some implementations, the RAN 204 may be controlled or coordinated by a network controller, which may perform load balancing, network-level configuration, and/or other operations. The network controller may communicate with the RAN 204 via a wireless or wireline backhaul. In some implementations, the RAN 204 may include a network controller, a self-organizing network (SON) module or component, or a similar module or component. In other words, the RAN 204 may perform network control, scheduling, and/or network management functions (e.g., for uplink, downlink, and/or sidelink communications of the UE 202 covered by the RAN 204).

In some implementations, the core network 302 may include an example functional architecture in which systems and/or methods described herein may be implemented. For example, the core network 302 may include an example architecture of a 5G next generation (NG) core network included in a 5G wireless telecommunications system. While the example architecture of the core network 302 shown in FIG. 3 may be an example of a service-based architecture, in some implementations, the core network 302 may be implemented as a reference-point architecture and/or a 4G core network, among other examples.

As shown in FIG. 3, the core network 302 may include a number of functional elements. The functional elements may include, for example, a network slice selection function (NSSF) 305, a network exposure function (NEF) 310, an authentication server function (AUSF) 315, a unified data management (UDM) component 320, the PCF 208, an application function (AF) 330, the AMF 206, a session management function (SMF) 340, and/or a user plane function (UPF) 345. These functional elements may be communicatively connected via a message bus 350. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 305 includes one or more devices that select network slice instances for the UE 202. By providing network slicing, the NSSF 305 allows an operator to deploy multiple substantially independent end-to-end networks potentially with the same infrastructure. In some implementations, each slice may be customized for different services.

The NEF 310 includes one or more devices that support exposure of capabilities and/or events in the wireless telecommunications system to help other entities in the wireless telecommunications system discover network services.

The AUSF 315 includes one or more devices that act as an authentication server and support the process of authenticating the UE 202 in the wireless telecommunications system.

The UDM 320 includes one or more devices that store user data and profiles in the wireless telecommunications system. The UDM 320 may be used for fixed access and/or mobile access in the core network 302.

The PCF 208 includes one or more devices that provide a policy framework that incorporates network slicing, roaming, packet processing, and/or mobility management, among other examples.

The AF 330 includes one or more devices that support application influence on traffic routing, access to the NEF 310, and/or policy control, among other examples.

The AMF 206 includes one or more devices that act as a termination point for NAS signaling and/or mobility management, among other examples.

The SMF 340 includes one or more devices that support the establishment, modification, and release of communication sessions in the wireless telecommunications system. For example, the SMF 340 may configure traffic steering policies at the UPF 345 and/or may enforce user equipment internet protocol (IP) address allocation and policies, among other examples.

The UPF 345 includes one or more devices that serve as an anchor point for intraRAT and/or interRAT mobility. The UPF 345 may apply rules to packets, such as rules pertaining to packet routing, traffic reporting, and/or handling user plane QoS, among other examples.

The message bus 350 represents a communication structure for communication among the functional elements. In other words, the message bus 350 may permit communication between two or more functional elements.

The data network 355 includes one or more wired and/or wireless data networks. For example, the data network 355 may include an IP multimedia subsystem (IMS), a PLMN, a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks. In some implementations, the DNN described above in connection with FIGS. 1A-1G and FIGS. 2A-2B may be associated with the data network 355 (e.g., the DNN may be an identifier uniquely identifying the data network 355 and/or defining an interface between the core network 302 and the data network 355).

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

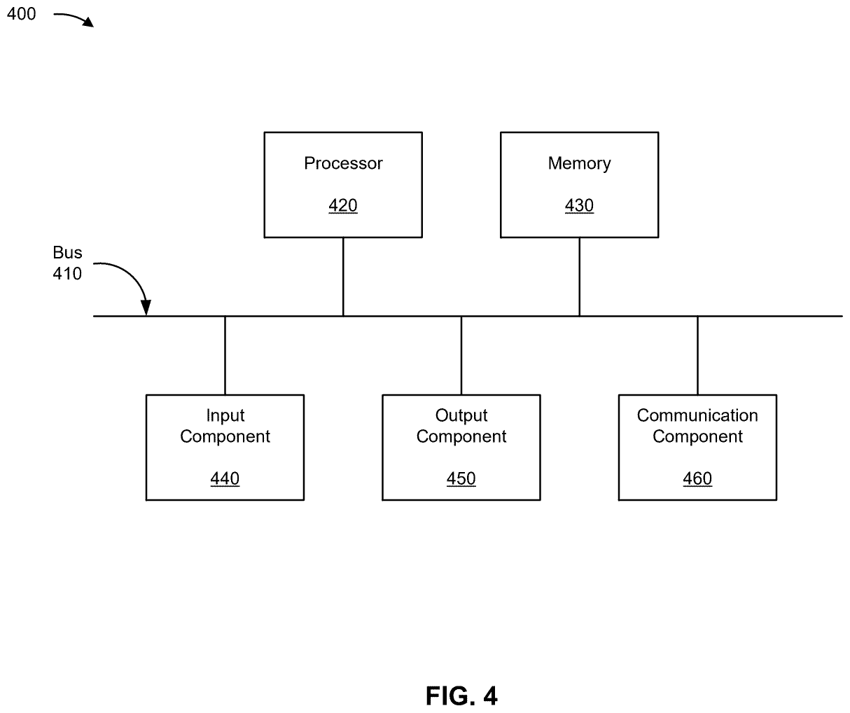

FIG. 4 is a diagram of example components of a device 400 associated with enabling slice subscription changes. The device 400 may correspond to the network-connected device 102, the network entity 104, the UE 202, the RAN 204, the AMF 206, the PCF 208, the NSSF 305, the NEF 310, the AUSF 315, the UDM 320, the AF 330, the SMF 340, the UPF 345, and/or a device associated with the data network 355. In some implementations, the network-connected device 102, the network entity 104, the UE 202, the RAN 204, the AMF 206, the PCF 208, the NSSF 305, the NEF 310, the AUSF 315, the UDM 320, the AF 330, the SMF 340, the UPF 345, and/or a device associated with the data network 355 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include RAM, read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

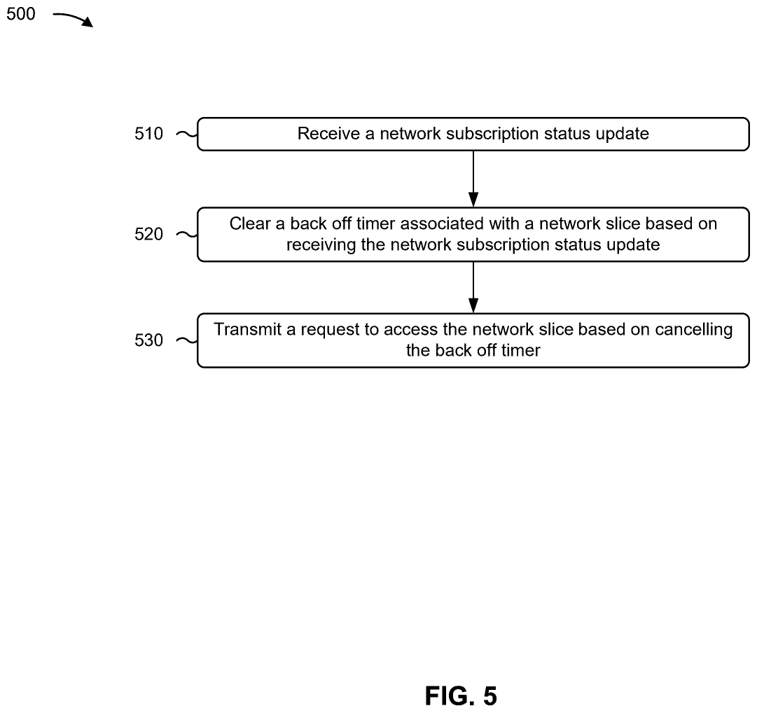

FIG. 5 is a flowchart of an example process 500 associated with enabling slice subscription changes. In some implementations, one or more process blocks of FIG. 5 may be performed by a network-connected device (e.g., network-connected device 102 and/or UE 202). In some implementations, one or more process blocks of FIG. 5 may be performed by another device or a group of devices separate from or including the network-connected device, such as a network entity (e.g., network entity 104), a RAN device (e.g., RAN 204), an AMF device (e.g., AMF 206), a PCF device (e.g., PCF 208), an NSSF device (e.g., NSSF 305), an NEF device (e.g., NEF 310), an AUSF device (e.g., AUSF 315), a UDM device (e.g., UDM 320), an AF device (e.g., AF 330), an SMF device (e.g., SMF 340), a UPF device (e.g., UPF 345), and/or a data network device (e.g., a device associated with the data network 355). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, from a network entity, a network subscription status update (block 510). In some implementations, the network subscription status update may indicate that a network-connected device is permitted to access a network slice for which the network-connected device has an associated back off timer running. In some implementations, the network subscription status update is associated with a URSP rules communication (e.g., a URSP policies push). Additionally, or alternatively, the network slice may be associated with an S-NSSAI and DNN combination. For example, the network-connected device may receive, from the network entity, a network subscription status update (e.g., a URSP policies push), with the network subscription status update indicating that the network-connected device is permitted to access a network slice (e.g., a slice associated with an S-NSSAI and DNN combination) for which the network-connected device has an associated back off timer running, as described above.

In some implementations, the back off timer may be associated with a period of time during which PDU session requests associated with the network slice are not to be transmitted by the network-connected device. For example, the back off timer may be associated with one of a period of time indicated to the network-connected device by the network entity, or a period of time hard-coded on the network-connected device. Additionally, or alternatively, process 500 may include starting the back off timer in response to receiving (e.g., from the network entity) a permanent failure error code.

As further shown in FIG. 5, process 500 may include clearing a back off timer associated with a network slice based on receiving the network subscription status update (block 520). For example, in implementations in which the network subscription status update indicates that the network-connected device is permitted to access a network slice for which the network-connected device has an associated back off timer running, the network-connected device may clear the back off timer for the network slice indicated by the network subscription status update, as described above.

As further shown in FIG. 5, process 500 may include transmitting a request to access the network slice, such as by transmitting a PDU session request associated with the network slice, based on clearing the back off timer (block 530). For example, the network-connected device may transmit a PDU session request associated with the network slice based on clearing the back off timer, as described above. In some implementations, such as implementations in which the network slice is associated with an S-NSSAI and DNN combination, the PDU session request may indicate the S-NSSAI and DNN combination. Moreover, process 500 may include receiving, by the network-connected device from the network entity, a PDU session accept communication based on transmitting the PDU session request.

In some implementations, process 500 may include transmitting, to the network entity and prior to receiving the network subscription status update, another PDU session request associated with the network slice. In such implementations, process 500 may include receiving, from the network entity, a PDU session reject communication in response to transmitting the other PDU session request and starting the back off timer based on receiving the PDU session reject communication.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a network-connected device from a network entity, a network subscription status update, wherein the network subscription status update indicates that the network-connected device is permitted to access a network slice for which the network-connected device has an associated back off timer running;
clearing, by the network-connected device, the associated back off timer based on receiving the network subscription status update; and
transmitting, by the network-connected device to the network entity, a packet data unit (PDU) session request associated with the network slice based on clearing the associated back off timer.

2. The method of claim 1, further comprising:
transmitting, by the network-connected device to the network entity and prior to receiving the network subscription status update, another PDU session request associated with the network slice;
receiving, by the network-connected device from the network entity, a PDU session reject communication in response to transmitting the other PDU session request; and
starting, by the network-connected device, the associated back off timer based on receiving the PDU session reject communication.

3. The method of claim 1, wherein the associated back off timer is associated with a period of time during which PDU session requests associated with the network slice are not to be transmitted by the network-connected device.

4. The method of claim 1, further comprising starting, by the network-connected device, the associated back off timer in response to receiving a permanent failure error code.

5. The method of claim 1, wherein the network subscription status update is associated with a user equipment route selection policy rules communication.

6. The method of claim 1, wherein the network slice is associated with a single network slice selection assistance information (S-NSSAI) and data network name (DNN) combination, and
wherein the PDU session request indicates the S-NSSAI and DNN combination.

7. The method of claim 1, further comprising receiving, by the network-connected device from the network entity, a PDU session accept communication based on transmitting the PDU session request.

8. The method of claim 1, wherein the associated back off timer is associated with one of:
a period of time indicated to the network-connected device by the network entity, or
a period of time coded on the network-connected device.

9. A device, comprising:
one or more processors configured to:
receive, from a network entity, an update to a set of user equipment route selection (URSP) rules associated with the device;
determine that the update to the set of URSP rules corresponds to a previously rejected packet data unit (PDU) session request associated with a network slice for which a back off timer is running at the device;
clear the back off timer running at the device in response to receiving the update to the set of URSP rules; and
transmit, to the network entity, a new PDU session request associated with the network slice.

10. The device of claim 9, wherein the one or more processors are further configured to:
receive, from the network entity, a rejection of the PDU session request with a permanent failure error code prior to receiving the update to the set of URSP rules; and
start the back off timer in response to receiving the permanent failure error code.

11. The device of claim 9, wherein the back off timer is based on one of a network-provided value or a pre-configured value.

12. The device of claim 9, wherein the one or more processors are further configured to:
receive, from the network entity, a PDU session reject communication in response to transmitting the previously rejected PDU session request; and
start the back off timer based on receiving the PDU session reject communication.

13. The device of claim 9, wherein the back off timer is associated with a period of time during which PDU session requests associated with the network slice are not to be transmitted by the device.

14. The device of claim 9, wherein the network slice is associated with a single network slice selection assistance information (S-NSSAI) and data network name (DNN) combination, and
wherein the new PDU session request indicates the S-NSSAI and DNN combination.

15. The device of claim 9, wherein the one or more processors are further configured to receive, from the network entity, a PDU session accept communication based on transmitting the new PDU session request.

16. A non-transitory computer-readable medium storing a set of instructions, the set of instructions comprising:
one or more instructions that, when executed by one or more processors of a device, cause the device to:
receive updated user equipment route selection (URSP) rules indicating an allowed single network slice selection assistance information (S-NSSAI) and data network name (DNN) combination;
determine a change in a network slice subscription based on the updated URSP rules; and
clear one or more back off timers for one or more packet data unit (PDU) sessions that are associated with the allowed S-NSSAI and DNN combination based on determining the change in the network slice subscription.

17. The non-transitory computer-readable medium of claim 16, wherein the one or more instructions, when executed by the one or more processors, further cause the device to transmit a PDU session request associated with a PDU session, of the one or more PDU sessions that are associated with the allowed S-NSSAI and DNN combination.

18. The non-transitory computer-readable medium of claim 17, wherein the one or more instructions, when executed by the one or more processors, further cause the device to receive a PDU session accept communication based on transmitting the PDU session request.

19. The non-transitory computer-readable medium of claim 16, wherein the one or more instructions, when executed by the one or more processors, further cause the device to:
transmit, prior to receiving the updated URSP rules, another PDU session request associated with the allowed S-NSSAI and DNN combination;
receive a PDU session reject communication in response to transmitting the other PDU session request; and
start a back off timer, of the one or more back off timers, based on receiving the PDU session reject communication.

20. The non-transitory computer-readable medium of claim 16, wherein the one or more back off timers are associated with a period of time during which PDU session requests associated with the allowed S-NSSAI and DNN combination are not to be transmitted by the device.
